(19) United States
(12) Patent Application Publication
(10) Pub. No.: US 2018/0276638 A1
(43) Pub. Date: Sep. 27, 2018

(54) PORTABLE POINT-OF-SALE APPARATUS

(71) Applicant: TOSHIBA TEC KABUSHIKI KAISHA, Tokyo (JP)

(72) Inventor: Shinya GONDA, Osaka Osaka (JP)

(21) Appl. No.: 15/905,938

(22) Filed: Feb. 27, 2018

(30) Foreign Application Priority Data
Mar. 22, 2017 (JP) 2017-056010

(51) Int. Cl. G06Q 20/20; G06K 7/14; G06Q 20/34

(52) U.S. Cl. CPC G06Q 20/208; G06Q 20/34; G06K 7/1417

(57) ABSTRACT

A portable point-of-sale apparatus includes a display, an input device configured to capture symbol information affixed on a commodity, and a processor. The processor is configured to acquire commodity identification information for identifying the commodity based on the symbol information, perform sales registration processing for the commodity based on the acquired commodity identification information, and control the display to display a symbol image including the commodity identification information of the commodity in order for a settlement apparatus to read the symbol image.

### CROSS-REFERENCE TO RELATED APPLICATION

This application is based upon and claims the benefit of priority from Japanese Patent Application No. 2017-056010, filed Mar. 22, 2017, the entire contents of which are incorporated herein by reference.

### FIELD

Embodiments described herein relate generally to a portable point-of-sale apparatus.

### BACKGROUND

Conventionally, a sales registration processing and a settlement processing for commodities to be purchased in a store are performed by a store clerk with a POS terminal.

Recently, a self-service checkout POS terminal on which a customer can perform a checkout operation including a sales registration operation and a settlement operation by him/herself is known. With the self-service checkout POS terminal, it is possible to reduce the number of store personnel such as store clerk who performs the operations on the POS terminal described above.

However, in the self-service checkout POS terminal, if the customer who is unfamiliar with operations described above performs the operations by him/herself and thus he or she may take time to execute the operations, a queue for waiting for settlement may form in front of the POS terminal at a time the store may be crowded with customers.

### DESCRIPTION OF THE DRAWINGS

FIG. 1 is a schematic diagram illustrating a system including a portable terminal according to an embodiment;

FIG. 2 is a block diagram illustrating a hardware configuration of a POS terminal;

FIG. 3 is a block diagram illustrating a hardware configuration of a server;

FIG. 4 is a block diagram illustrating a hardware configuration of the portable terminal;

FIG. 5 is a flow chart illustrating a flow of control processing of the server;

FIG. 6 is a block diagram illustrating functional components of the portable terminal;

FIG. 7 is a flow chart illustrating a flow of control processing of the portable terminal;

FIG. 8 is a diagram illustrating an example of a screen displayed on a display unit of the portable terminal;

FIG. 9 is a diagram illustrating an example of another screen displayed on the display unit of the portable terminal;

FIG. 10 is a diagram illustrating an example of still another screen displayed on the display unit of the portable terminal;

FIG. 11 is a block diagram illustrating functional components of the POS terminal; and

FIG. 12 is a flow chart illustrating a flow of control processing of the POS terminal.

### DETAILED DESCRIPTION

According to one embodiment, a portable point-of-sale terminal includes a display, an input device configured to capture symbol information affixed on a commodity, and a processor. The processor is configured to acquire commodity identification information for identifying the commodity based on the symbol information, perform sales registration processing for the commodity based on the acquired commodity identification information, and control the display to display a symbol image including the commodity identification information of the commodity in order for a settlement apparatus to read the symbol image.

Hereinafter, a commodity information processing apparatus according to a present embodiment is specifically described with reference to the accompanying drawings. In the embodiment, a portable terminal is described as an example of the commodity information processing apparatus. Further, a POS (Point Of Sales) terminal is described as an example of a settlement apparatus. Note that, the invention is not limited to the embodiments described below.

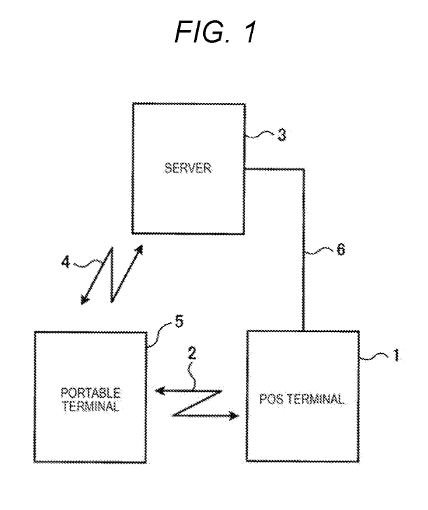

FIG. 1 is a schematic diagram illustrating a system including a portable terminal according to the embodiment. As illustrated in FIG. 1, the system is provided with a POS terminal 1 (a plurality of POS terminals 1 may be provided) on which a customer him/herself performs a sales registration operation and a settlement operation of commodities to be purchased. The sales registration operation and the settlement operation carried out by the customer is described later. In addition, the system is provided with a server 3. The POS terminal 1 and the server 3 are connected to each other via a communication network 6 such as a LAN (Local Area Network). Further, the system is provided with a portable terminal 5. The portable terminal 5 and the POS terminal 1 are connected to each other via a communication network 2 such as Wi-Fi (Registered Trademark: one of the standards of wireless LAN). In addition, the portable terminal 5 and the server 3 are connected to each other via a communication network 4 such as Wi-Fi or the Internet. The communication network 2 and the communication network 4 may be a common communication network.

The POS terminal 1 performs sales registration and settlement of commodities to be purchased by the customer in the store. The sales registration processing is referred to a processing in which information of the commodity (a commodity code, a commodity name, a unit price, and the like) is displayed based on a commodity code (commodity identification information) acquired from an input symbol such as a barcode or a two-dimensional code attached to the commodity, and is stored in a commodity information unit 131. In addition, the settlement processing is referred to a processing in which settlement information, such as a total amount relating to one transaction, a deposit amount received from a customer, and change, is displayed based on the commodity information sales-registered, and a receipt on which the commodity information and settlement information are printed is issued. One transaction includes the sales registration processing and the settlement processing.

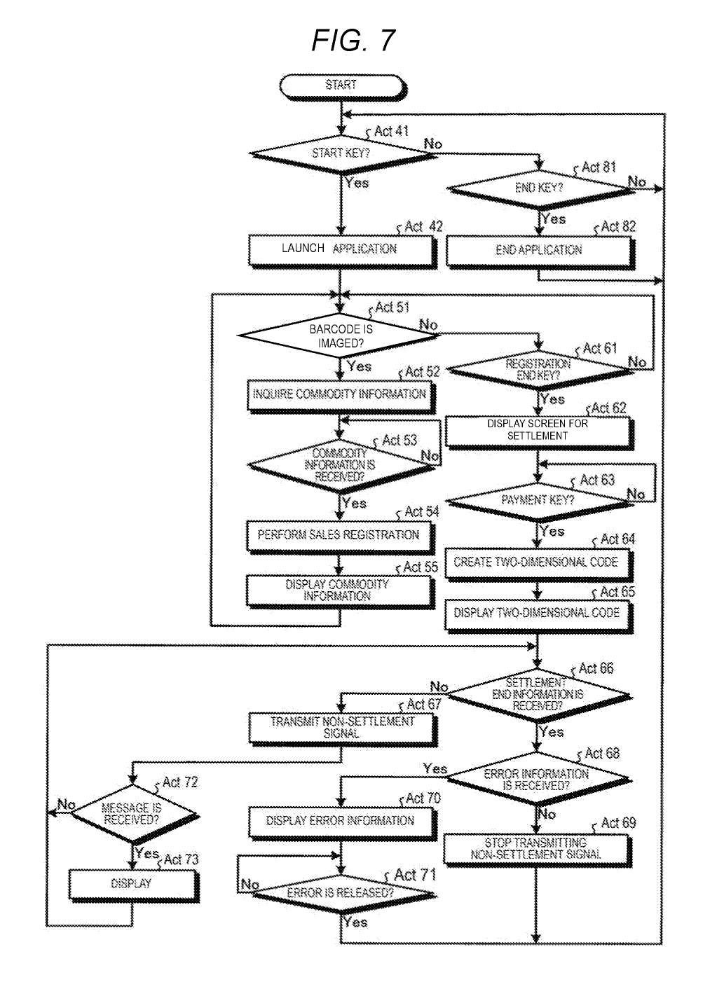

The server 3 collects commodity information and the settlement information of the commodities transacted by the POS terminal 1. Further, the server 3 transmits commodity master information including the collected commodity information to the POS terminal 1. The server 3 also transmits an application software described later to the portable terminal 5. The application software enables the portable terminal 5 to execute a control shown in FIG. 7.

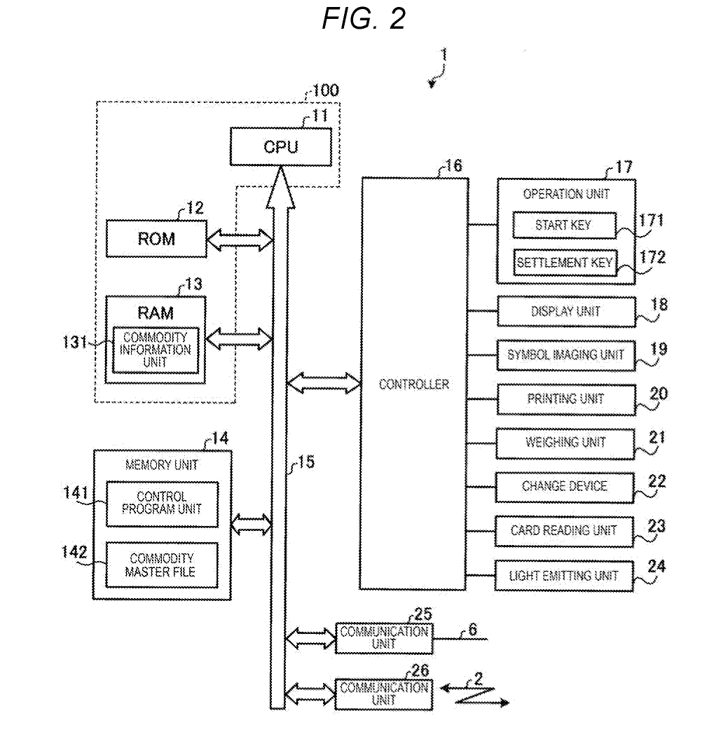

Next, the POS terminal 1 is described. FIG. 2 is a block diagram illustrating hardware components of the POS terminal 1. As illustrated in FIG. 2, the POS terminal 1 is provided with a CPU (Central Processing Unit) 11, a ROM (Read Only Memory) 12, a RAM (Random Access Memory) 13, a memory unit 14, and the like. The CPU 11 is a main controller. The ROM 12 stores various kinds of programs. The RAM 13 stores various items of data thereon. The memory unit 14 stores various kinds of programs. The CPU 11, the ROM 12, the RAM 13, and the memory unit 14 are connected to each other via a data bus 15. The CPU 11, the ROM 12, and the RAM 13 make up a control unit 100. The control unit 100 performs control processing described later by executing the control program, stored in the ROM 12 or the memory unit 14 and is loaded into the RAM 13, by the CPU 11.

The RAM 13 includes a commodity information unit 131 for storing commodity information. The memory unit 14 is constituted by an HDD (Hard Disk Drive) and a nonvolatile memory such as a flash memory, in which stored information is held even if the power is turned off. The memory unit 14 is also provided with a control program unit 141 for storing a control program and a commodity master file 142. The commodity master file 142 stores commodity information such as a commodity name, commodity price, and commodity weight in association with a commodity code for identifying the commodity.

The control unit 100 is connected to an operation unit including a touch panel, a display unit 18, a symbol imaging unit 19, a printing unit 20, a weighing unit 21, a change device 22, a card reading unit 23, and a light emitting unit 24 via the data bus 15 and a controller 16.

The operation unit 17 includes a start key 171 and a settlement key 172 which correspond to display of a “start key” and a “settlement key” on the display unit 18. The start key 171 is operated by a customer to start the operation of the POS terminal 1. The settlement key 172 is operated by the customer if the sales registration operation of the checkout processing on the POS terminal 1 is completed and the checkout processing proceeds to the settlement operation. If the settlement key 172 is operated by the customer, the POS terminal 1 performs settlement processing according to the commodities (commodities to be purchased by the customer) which are sales-registered. Note that, in the following description, “the key, provided in the operation unit 17, which corresponds to the display of the key on the display unit 18” is simplified such as “the key displayed on the display unit 18.”

The display unit 18 displays the commodity information of the sales-registered commodity. In addition, the display unit 18 displays the settlement information generated from the settlement processing. The symbol imaging unit 19 images a barcode affixed on the commodity. The POS terminal 1 acquires symbol information including a sequence of numbers from the imaged barcode. The symbol imaging unit 19 also images a two-dimensional code displayed on the portable terminal 5. The two-dimensional code, which includes a commodity code for identifying a commodity imaged by an imaging unit 59 of the portable terminal 5, is specifically described later. The two-dimensional code also includes information indicating that a payment key 574 described later has been operated and thus a settlement operation is to be performed. Further, the two-dimensional code includes a terminal identification code for identifying the portable terminal 5 which displays the two-dimensional code thereon.

The printing unit 20 prints the commodity information and the settlement information of the commodity on which the settlement processing is performed on a receipt paper to issue the printed receipt. The weighing unit 21 is a table on which a basket in which commodities are put is placed. The weighing unit 21 weighs the weight of the commodities put in the basket placed thereon. The POS terminal 1 verifies the weight of the commodity in real time to prevent an undesirable behavior by the customer at the time of the commodity registration operation. Specifically, if the basket in which commodities are put is placed on the weighing unit 21, the weighing unit 21 weighs total weight of the commodities put in the basket before the registration operation is performed. When the customer takes out the commodities from the basket one by one for the registration operation, a total weight resulting from decrease of the weight of the commodity taken out is measured. By assuming that a difference between a weight of the basket measured before a commodity is taken out from the basket and a weight of the basket measured after the commodity is taken out from the basket is the weight of the commodity taken out from the basket by the customer, and comparing the difference, which is assumed as the weight of the commodity, with the weight of the commodity known based on the commodity information of the commodity, if both are matched with each other, it is determined that there is no undesirable act by the customer. Further, the POS terminal 1 confirms whether or not there is undesirable act by the customer based on the total weight of the measured or registered commodities (after the registration operation is performed) and the weight of the commodities weighed in advance (before the registration operation is performed). If both weights are matched with each other, it is determined that there is no undesirable act by the customer.

The change device 22 discharges change in the amount to be dispensed to the customer if the change is calculated in the settlement processing. The card reading unit 23 is operated if the payment is made by using a card such as a credit card or an electronic money card. The light emitting unit 24 is supported by a pole extending upward and positioned above the POS terminal 1. The light emitting unit 24 is a device used in a case in which the customer operates the light emitting unit 24 to emit the light to call a store clerk if the customer mistakes the operation of the POS terminal 1, the customer who is unfamiliar with the operation of the POS terminal 1 needs a help by the store clerk, or an error occurs in the POS terminal 1.

The control unit 100 is connected to a communication unit 25 via the data bus 15. The communication unit 25 carries out transmission/reception of information to or from the server 3 via the communication network 6. Further, the control unit 100 is connected to a communication unit 26 via the data bus 15. The communication unit 26 carries out transmission/reception of information to or from the portable terminal 5 via the communication network 2.

The customer places the basket in which the commodities are put on the weighing unit 21. Next, the customer takes out one of the commodities from the basket and passes the commodity in front of the POS terminal 1. Thus, the barcode affixed on the commodity is scanned by the symbol imaging unit 19 while the commodity passes in front of the POS terminal 1. The operation in which the customer hold the commodity to the symbol imaging unit 19 to scan the barcode is called as a sales registration operation. The symbol imaging unit 19 of the POS terminal 1 captures the image of the bar code affixed on the commodity. The POS terminal 1 inputs symbol information of the captured symbol image. Then, the POS terminal 1 acquires the commodity code for identifying the commodity corresponding to the input symbol information. The POS terminal 1 reads out the commodity information specified with the commodity code, and performs the sales registration on the commodity passed through the weight check.

If the sales registration processing on all of the commodities in the basket is performed, the customer operates the settlement key 172. Then, the POS terminal 1 performs the settlement processing based on the commodity information of the commodities which are sales-registered. If the settlement processing is completed, the transaction completed. The customer performs packing of the commodities on which the settlement processing is performed.

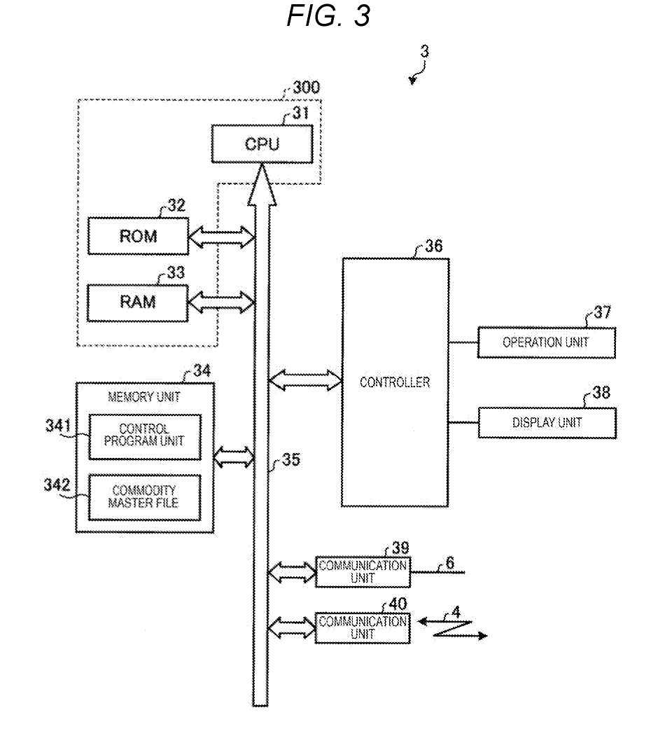

Next, the server 3 is described. FIG. 3 is a block diagram illustrating a hardware configuration of the server 3. As illustrated in FIG. 3, the server 3 is a computer equipped with a CPU 31, a ROM 32, a RAM 33, and a memory unit 34. The CPU 31 is a main controller. The ROM 32 stores various kinds of programs. The RAM 33 loads various items of data. The memory unit 34 stores various kinds of programs. The CPU 31, the ROM 32, the RAM 33, and the memory unit 34 are connected to each other via a data bus 35. The CPU 31, the ROM 32, and the RAM 33 constitute a control unit 300. The control unit 300 performs control processing described later if the CPU 31 operates in accordance with the control program, stored in the ROM 32 or the memory unit 34, which is loaded into the RAM 33.

The memory unit 34 includes an HDD or a nonvolatile memory such as a flash memory which holds stored information even if the power is turned off. The memory unit 34 is provided with a control program unit 341 that stores a control program and a commodity master file 342. The commodity master file 342 has the same items as the commodity master file 142 shown in FIG. 2.

The control unit 300 is connected to an operation unit and a display unit 38 via the data bus 35 and the controller 36. The operation unit 37 is a keyboard provided with various keys. The display unit 38 displays various information.

The control unit 300 is also connected to a communication unit 39 via the data bus 35. The communication unit 39 carries out transmission/reception of information to or from the POS terminal 1 via the communication network 6. Further, the control unit 300 is connected to a communication unit 40 via the data bus 35. The communication unit 40 carries out transmission/reception of information to or from the portable terminal 5 via the communication network 4.

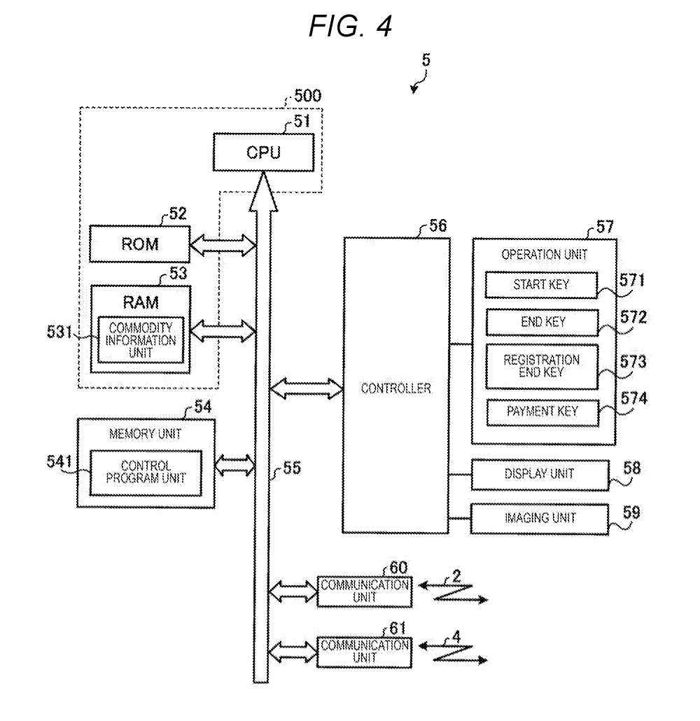

Next, the portable terminal 5 is described. The portable terminal 5 can be carried by a customer. The portable terminal 5 includes, for example, a smart phone and a PDA (Portable Digital Assistant). FIG. 4 is a block diagram illustrating a hardware configuration of the portable terminal 5. As illustrated in FIG. 4, the portable terminal 5 is a computer provided with a CPU 51, a ROM 52, a RAM 53, and a memory unit 54. The CPU 51 is a main controller. The ROM stores various kinds of programs. The RAM 53 stores various data. The memory unit 54 stores various kinds of programs. The CPU 51, the ROM 52, the RAM 53, and the memory unit 54 are connected to each other via a data bus 55. The CPU 51, the ROM 52, and the RAM 53 make up a control unit 500. The control unit 500 performs control processing described later if the CPU 51 operates in accordance with the control program, stored in the ROM 52 or the memory unit 54, which is loaded into the RAM 53.

The RAM 53 includes a commodity information unit 531. The commodity information unit 531 stores commodity information of the commodity on which the bar code, imaged by the imaging unit 59 described later, is affixed. The memory unit 54 includes an HDD or a nonvolatile memory such as a flash memory which holds stored information even if the power is turned off. The memory unit 54 is provided with a control program unit 341 that stores a control program. The control program unit 541 stores application software down-loaded from the server 3 in addition to the control program. The application software is operable on the control program. The control unit 500 performs control processing described later in accordance with the application software.

The control unit 500 is connected to an operation unit 57, a display unit 58, and the imaging unit 59 via the data bus 55 and the controller 56. The operation unit 57 is a touch panel provided on the display unit 58. The operation unit 57 is provided with a start key 571, an end key 572, a registration end key 573, and a payment key 574. The display unit 58 displays various information.

The imaging unit 59 is a camera formed of, for example, a CCD image sensor. The imaging unit 59 captures an image of the barcode affixed on the commodity. The portable terminal 5 acquires the symbol information represented by numbers by analyzing the captured image of the barcode.

The control unit 500 is also connected to a communication unit 60 and a communication unit 61 via the data bus 55. The communication unit 60 performs transmission/reception of information to or from the POS terminal 1 via the communication network 2. Further, the communication unit 61 performs transmission/reception of information to or from the server 3 via the communication network 4.

The portable terminal 5 may be a terminal carried by the customer. In addition, the portable terminal 5 may be a terminal distributed to the customer at entrance of the store, and is collected at exit of the store. Further, the portable terminal 5 may be a terminal detachably attached to a cart in which the commodities are put, or a cart on which the basket in which the commodities are put is placed.

In a case of the portable terminal 5 carried by the customer, application software can be downloaded from the server 3 via the communication network 4 by the customer. In a case of the portable terminal 5 distributed at the entrance of the store, the application software is downloaded in advance and is launched.

If the application software is downloaded to the portable terminal 5 from the server 3, the operation unit 57 has functions of the start key 571, the end key 572, the registration end key 573, and the payment key 574.

Such a portable terminal 5 acquires symbol information based on the barcode affixed on the commodity imaged by the imaging unit 59, and acquires a commodity code for identifying the commodity based on the symbol information. Then, the portable terminal 5 performs the sales registration processing based on the acquired commodity code. In the sales registration processing, the portable terminal 5 stores the commodity information in the commodity information unit 531 (refer to FIG. 4). Then, the portable terminal 5 generates a two-dimensional code including the commodity code to display it thereon. The two-dimensional code includes information indicating that the payment key 574 is operated to perform a closing operation. Further, the two-dimensional code includes a terminal identification code for identifying the portable terminal 5.

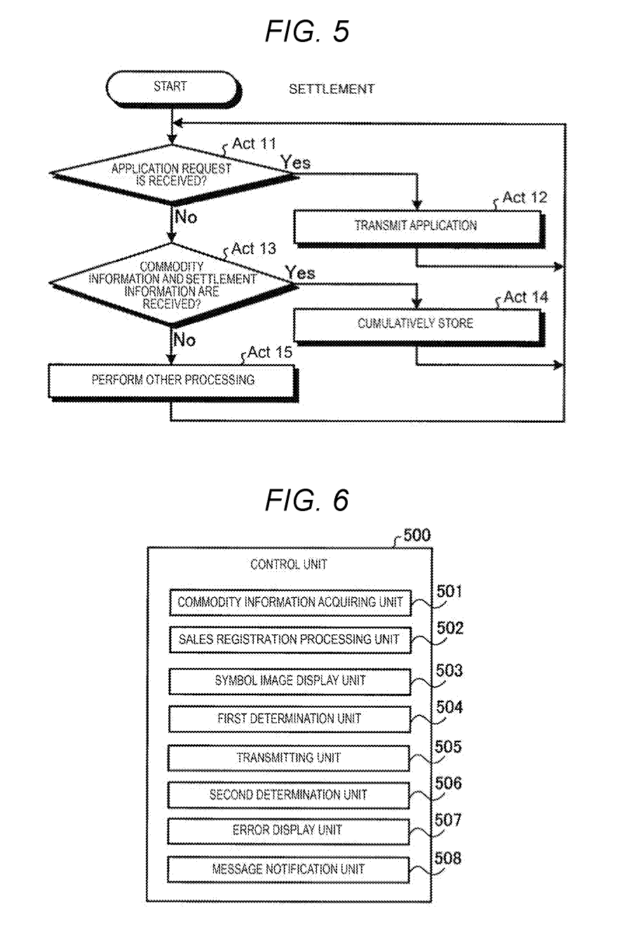

Hereinafter, the control of the server 3, the portable terminal 5, and the POS terminal 1 is described. A control processing of the server 3 is described. FIG. 5 is a flow chart illustrating a flow of control processing of the server 3. As illustrated in FIG. 5, the control unit 300 of the server 3 determines whether or not a request for download of the application software is received from the portable terminal 5 (Act 11). If the control unit 300 of the server 3 determines that a request for download of the application software is received from the portable terminal 5 (Yes in Act 11), the control unit 300 transmits the application software to the portable terminal 5 that transmitted the request to the server 3 (Act 12). Then, the control unit 300 returns to the processing in Act 11.

If it is determined that the request for download of the application software is not received from the portable terminal 5 (No in Act 11), the control unit 300 determines whether or not the commodity information and the settlement information are received from the POS terminal 1 (Act 13). If it is determined that the commodity information and the settlement information are received from the POS terminal 1 (Yes in Act 13), the control unit 300 cumulatively stores the received commodity information and the settlement information (Act 14). The control unit 300 manages sales information of the store based on the cumulatively stored commodity information and settlement information. Then, the control unit 300 returns to the processing in Act 11. If it is determined that the commodity information and the settlement information are not received from the POS terminal 1 (No in Act 13), the control unit 300 performs other processing (Act 15). Then, the control unit 300 returns to the processing in Act 11.

As described above, the server 3 transmits the application software in response to the request from the portable terminal 5.

Next, the control processing of the portable terminal 5 is described. The customer launches the application software downloaded in the portable terminal 5. Then, the customer images a barcode of a commodity to be purchased in commodities displayed in the store by the imaging unit 59 of the portable terminal 5. The customer puts the commodity, in which the barcode is already imaged by the imaging unit 59, into his or her basket.

FIG. 6 is a block diagram illustrating functional components of the portable terminal 5. The control unit 500 operates according to the control program stored in the ROM 52 or the control program unit 541 of the memory unit 54 to function as a commodity information acquiring unit 501, a sales registration processing unit 502, a symbol image display unit 503, a first determination unit 504, a transmitting unit 505, a second determination unit 506, an error display unit 507, and a message notification unit 508.

The commodity information acquiring unit 501 has a function of acquiring a commodity code for identifying a commodity based on symbol information corresponding to a symbol image captured by the imaging unit 59.

The sales registration processing unit 502 has a function of performing the sales registration processing of the commodity based on the commodity identification code acquired by the commodity information acquiring unit 501.

The symbol image display unit 503 has a function of displaying the symbol image including the commodity code information of the commodity for one transaction which is sales-registered by the sales registration processing unit 502 on the display unit 58.

The first determination unit 504 has a function of determining whether or not the POS terminal 1 performs the settlement processing based on the symbol image displayed on the display unit 58.

The transmitting unit 505 has a function of transmitting a non-settlement signal indicating that the settlement processing is not yet performed in the transaction if the first determination unit 504 determines that the settlement processing is not yet performed based on the symbol image.

The second determination unit 506 has a function of determining whether or not error information relating to the weight check in the POS terminal 1 is received, based on the symbol image displayed on the display unit 58.

The error display unit 507 has a function of displaying the error information relating to the transaction on the display unit 58 if it is determined that the second determination unit 506 receives the error information.

The message notification unit 508 has a function of notifying a message indicating that the settlement received is not finished in response to the transmitted non-settlement signal.

FIG. 7 is a flow chart illustrating a flow of control processing of the portable terminal 5. As illustrated in FIG. 7, the control unit 500 of the portable terminal 5 determines whether or not the start key 571 is operated by the customer (Act 41). If it is determined that the start key 571 is operated (Yes in Act 41), the control unit 500 launches the application software downloaded to the portable terminal 5 (Act 42). Then, the control unit 500 determines whether or not the barcode affixed on the commodity is imaged by the imaging unit 59 of the portable terminal 5 (Act 51). If it is determined that the barcode affixed on the commodity is imaged by the imaging unit 59 of the portable terminal 5 (Yes in Act 51), the control unit 500 inputs symbol information by analyzing the imaged barcode. Then, the control unit 500 acquires the commodity code corresponding to the input symbol information. The control unit 500 transmits the commodity code to the POS terminal 1, and inquires the commodity information of the commodity identified by the acquired commodity code (Act 52). Then, the control unit 500 (in particular, the commodity information acquiring unit 501) determines whether or not the commodity information of the commodity identified by the transmitted commodity code is received from the POS terminal 1 (Act 53). The control unit 500 waits for until the commodity information of the commodity is received (No in Act 53). If it is determined that the commodity information is received from the POS terminal 1 (Yes in Act 53), the control unit 500 (in particular, the sales registration processing unit 502) performs the sales registration processing in which the received commodity information is stored in the commodity information unit 531 (Act 54). The control unit 500 causes the display unit 58 to display the received commodity information (Act 55). Then, the control unit 500 returns to the processing in Act 51.

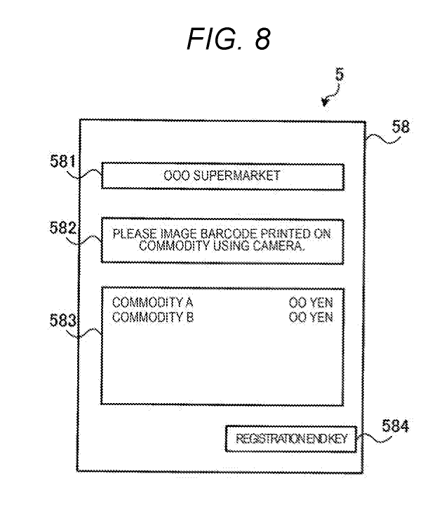

FIG. 8 is an example of a screen displayed on a display unit 58 on which the commodity information is indicated in Act 55. In FIG. 8, the control unit 500 causes the display unit 58 to display a store logo and a store name 581, the message 582 to the customer who operates the portable terminal 5, and the commodity information 583 of the commodity which is sales-registered. The message 582 reminds the customer to scan the commodity to be purchased with the imaging unit 59 of the portable terminal 5. In addition, the control unit 500 causes the display unit 58 to display the registration end key 584. The registration end key 584 is operated by the customer if the purchase of the commodity by the portable terminal 5 is completed.

Referring back to FIG. 7, in Act 51, if it is determined that the barcode affixed on the commodity is not imaged (No in Act 51), the control unit 500 determines whether or not the registration end key 573 is operated (Act 61). If it is determined that the registration end key 573 is operated (Yes in Act 61), the control unit 500 causes the display unit 58 to display a screen for settlement (Act 62).

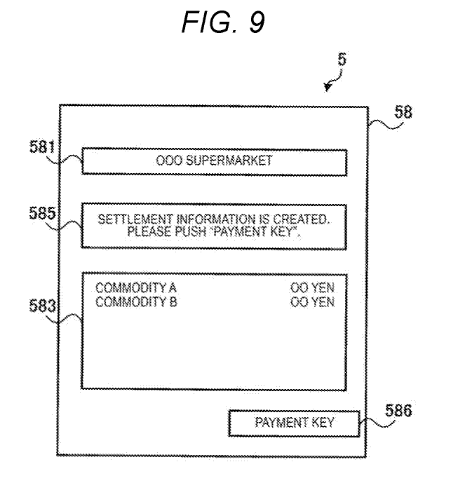

FIG. 9 is a diagram illustrating an example of the screen for settlement. In FIG. 9, the control unit 500 causes the display unit 58 to display a message 585 and a payment key 586 for instructing operation of the payment key 586 in addition to the store logo and the store name 581 and the commodity information 583. The payment key 586 is to close the transaction by completing the purchase of the commodity. The customer confirms the commodity to be purchased and then operates the payment key 586.

Referring back to FIG. 7, the control unit 500 determines whether or not the payment key 574 is operated (Act 63). The control unit 500 waits for until the operation on the payment key 574 is performed (No in Act 63). If it is determined that the payment key 574 is operated (Yes in Act 63), the control unit 500 generates a two-dimensional code (Act 64). The two-dimensional code includes commodity codes of commodity information of all of the commodities stored in the commodity information unit 531, information indicating that the payment key 574 is operated, and a terminal identification code for identifying the portable terminal 5. The control unit 500 (symbol image display unit 503) causes the display unit 58 to display the generated two-dimensional code at a size that can be imaged by the POS terminal 1 (Act 65).

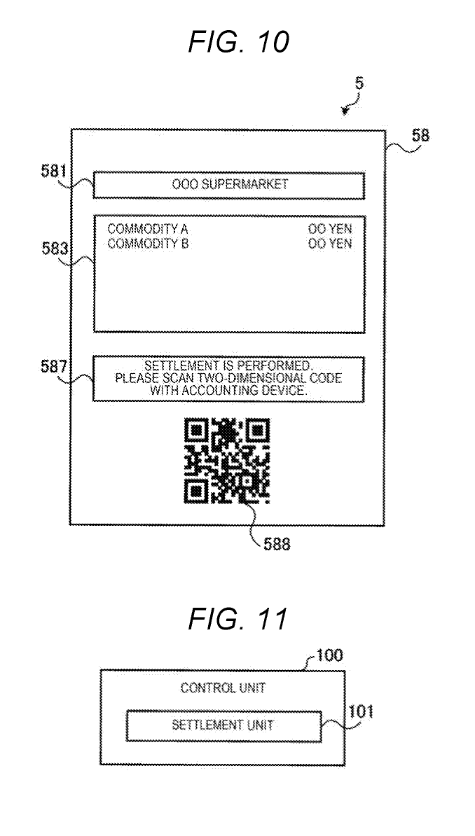

FIG. 10 is a diagram illustrating an example of the display in Act 65. In FIG. 10, the control unit 500 causes the display unit 58 to display the message 587 to the customer and the two-dimensional code 588 generated in the Act 64 in addition to the store logo, the store name 581 and the commodity information 583. The message 587 reminds the customer to scan the displayed two-dimensional code with the symbol imaging unit 19 of the POS terminal 1. The customer scans the two-dimensional code displayed on the display unit 58 with the symbol imaging unit 19.

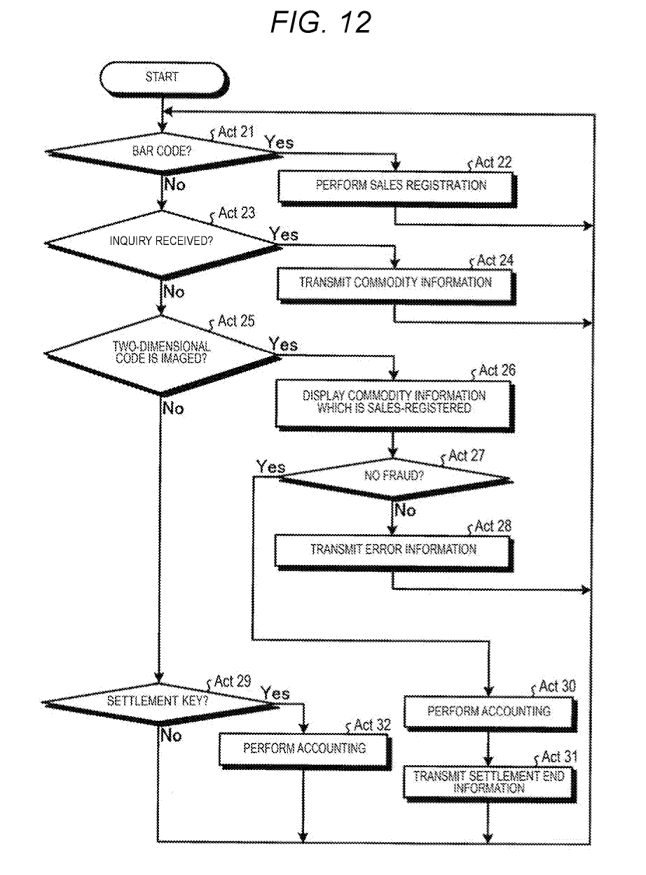

Referring back to FIG. 7, the control unit 500 (in particular, the first determination unit 504) determines whether or not settlement end information (described later in FIG. 12) indicating that the settlement processing is completed is received from the POS terminal 1 (Act 66). If it is determined that the settlement end information is not received (No in Act 66), the control unit 500 (in particular, the transmitting unit 505) transmits the non-settlement signal (Act 67).

The non-settlement signal is transmitted from the portable terminal 5 if the settlement of the transaction is not completed in the POS terminal 1. For example, if the customer who carries the portable terminal 5 for transmitting the non-settlement signal passes through a gate at the exit of the store, a device at the gate transmits the message indicating that the settlement is not yet completed to the portable terminal 5. The portable terminal 5 receives the message transmitted from the device the gate (not shown) arranged at the exit of the store. The message indicates that the settlement is not yet completed. The portable terminal 5 indicates the received message on the display unit 58 to notify that the settlement is not yet completed. Note that, the gate may be formed in an opening and closing type, and the gate is closed to prevent the customer from leaving the store if the non-settlement signal is received. In this way, it can prevent the customer from leaving store without completing the settlement.

The control unit 500 determines whether or not the message indicating that the settlement is not yet completed is received from the device at the gate (Act 72). If it is determined that the message indicating that the settlement is not yet completed is received (Yes in Act 72), the control unit 500 (in particular, the message notification unit 508) causes the display unit 58 to display the message indicating that the settlement is not yet completed to notify that the settlement is not yet completed (Act 73). Then, the control unit 500 returns to the processing in Act 66. On the other hand, if it is determined that the message indicating that the settlement is not yet completed is not received (No in Act 72), the control unit 500 returns to the processing in Act 66. Note that, in Act 72, the portable terminal 5 may determine that the message indicating that the settlement is not yet is received via the server 3. Further, in Act 73, the control unit 500 may activate a buzzer to notify that the settlement is not yet completed. In addition, in Act 73, a control unit 5005 may give above notification by both display on the display unit 58 and activation of the buzzer.

On the other hand, if it is determined that the settlement end information is received (Yes in Act 66), the control unit 500 (in particular, the second determination unit 506) determines whether or not error information relating to the weight check described later is received from the POS terminal 1 (Act 68). If it is determined that the error information relating to the weight check is not received (No in Act 68), the control unit 500 stops the non-settlement signal transmitted in Act 67 (Act 69). Then, the control unit 500 returns to the processing in Act 41. In this case, the above-described message is not displayed on the portable terminal 5 carried by the customer passing through the gate. On the other hand, if it is determined that the error information relating to the weight check is received (Yes in Act 68), the control unit 500 (in particular, the error display unit 507) causes the display unit 58 to display the message indicating that an error relating to the weight check occurs (Act 70). Further, the control unit 500 determines whether or not the error is released (Act 71). the control unit 500 waits for until the error is released (No in Act 71). If it is determined that the error is released (Yes in Act 71), the control unit 500 returns to the processing in Act 41. In other words, if the error information is received as a result of the weight check in the POS terminal 1, the portable terminal 5 continues to transmit the non-settlement signal, and the customer cannot go out of the store through the gate.

In Act 61, if it is determined that the registration end key 573 is not operated (No in Act 61), the control unit 500 returns to the processing in Act 51. In addition, in Act 41, if it is determined that it is not the operation to the start key 571 (No in Act 41), the control unit 500 determines whether or not the end key 572 is operated (Act 81). If it is determined that the end key 572 is operated (Yes in Act 81), the control unit 500 terminates the running application software activated in Act 42 (Act 82). Then, the control unit 500 returns to the processing in Act 41. If it is determined that the end key 572 is not operated (No in Act 81), the control unit 500 returns to the processing in Act 41.

Next, the control processing of the POS terminal 1 is described. The customer places the basket, in which commodities sales-registered by the portable terminal 5 are putplaced, on the weighing unit 21 of the POS terminal 1. The weighing unit 21 weighs the total weight of the commodities in the basket. The customer holds the two-dimensional code displayed on the portable terminal 5 in front of the symbol imaging unit 19. The symbol imaging unit 19 images the two-dimensional code.

FIG. 11 is a block diagram illustrating functional components of the POS terminal 1. The control unit 100 operates according to the control program stored in ROM 12 or the control program unit 141 of the memory unit 14 to function as a settlement unit 101.

The settlement unit 101 has a function of performing the settlement processing of the commodity even if the operation of the settlement key 172 is not operated if the symbol imaging unit 19 images the two-dimensional code including the commodity code for identifying the commodity which is sales-registered, and information indicating that a closing operation is performed.

FIG. 12 is a flow chart illustrating a flow of controlling the POS terminal 1. As illustrated in FIG. 12, the control unit 100 determines whether or not the barcode is imaged by the symbol imaging unit 19 (Act 21). If it is determined that the barcode is imaged by the symbol imaging unit 19 (Yes in Act 21), the control unit 100 reads out the commodity information of the commodity from the commodity master file 142 according to the commodity code acquired corresponding to the imaged barcode. Then the control unit 100 performs the sales registration processing of the commodity according to the read-out commodity code (Act 22). The control unit 100 returns to the processing in Act 21.

On the other hand, if the barcode is not imaged (No in Act 21), the control unit 100 determines whether or not an inquiry of the commodity information according to the commodity code is received from the portable terminal 5 (Act 23). If it is determined that the inquiry from the portable terminal 5 is received (Yes in Act 23), the control unit 100 reads out the commodity information corresponding to the commodity code from the commodity master file 142 to transmit the commodity information to the portable terminal 5 from which the inquiry is received (Act 24). Then, the control unit 100 returns to the processing in Act 21.

If it is determined that the inquiry from the portable terminal 5 is not received (No in Act 23), the control unit 100 determines whether or not the symbol imaging unit 19 images the two-dimensional code displayed on the portable terminal 5 (Act 25). If it is determined that the two-dimensional code is imaged (Yes in Act 25), the control unit 100 extracts all commodity codes included in the two-dimensional code. Then, the control unit 100 reads out the commodity information from the commodity master file 142 corresponding to the extracted commodity codes. The control unit 100 causes the display unit 58 to display the read-out commodity information (Act 26). Further, the control unit 100 stores the commodity information in the commodity information unit 131.

Next, the control unit 100 calculates the total weight of all commodities in which each weight of the commodities read out of the commodity master file 142 is added. The control unit 100 compares the total weight of the commodities weighed by the weighing unit 21 with the total weight calculated. If both are matched with each other, the control unit 100 determines that there is no undesirable act by the customer. If both are not matched with each other, the control unit 100 determines that there is an undesirable act by the customer.

The control unit 100 determines whether or not there is an undesirable act by the customer (Act 27). If it is determined that there is no undesirable act by the customer (Yes in Act 27), the control unit 100 (in particular, the settlement unit 101) performs the settlement processing based on the commodity information (in particular, the commodity information displayed on the display unit 18) stored in the commodity information unit 131 (Act 30). The control unit 100 performs the settlement processing even if the settlement key 172 is not operated based on the assumption that the two-dimensional code including information indicating that a closing operation was performed, is imaged. Since the closing operation was performed at the portable terminal 5, it is not required to perform the operation of the settlement key 172 again at the POS terminal 1. In other words, the operation on the settlement key 172 can be omitted at the POS terminal 1. Then, the control unit 100 transmits the settlement end information indicating that the settlement processing is completed to the portable terminal 5 identified by the terminal identification code (Act 31). Then, the control unit 100 returns to the processing in Act 21. On the other hand, if it is determined that there is an undesirable act or there is a probability of conducting an undesirable act by the customer (No in Act 27), the control unit 100 transmits the error information relating to the weight check to the portable terminal 5 based on the terminal identification code included in the imaged two-dimensional code (Act 28). Then, the control unit 100 returns to the processing in Act 21.

If it is determined that the two-dimensional code displayed on the portable terminal 5 is not imaged (No in Act 25), the control unit 100 determines whether or not the settlement key 172 is operated (Act 29). If it is determined that the settlement key 172 is operated (Yes in Act 29), the control unit 100 performs the settlement processing based on the commodity information stored in the commodity information unit 131 (Act 32). Then, the control unit 100 returns to the processing in Act 21. If it is determined that the settlement key 172 is not operated (No in Act 29), the control unit 100 returns to the processing in Act 21.

According to the present embodiment described above, the two-dimensional code including the commodity code of the commodity subject to the settlement processing in the POS terminal 1 is displayed on the portable terminal 5, and thus the settlement processing in the POS terminal 1 is smoothly performed. Therefore, it can reduce the number of people who are queued in front of the POS terminal 1 to wait for the settlement operation.

In the present embodiment, the POS terminal 1 images the two-dimensional code displayed on the portable terminal 5 to perform the settlement processing. For this reason, the number of peoples formed in line in front of the POS terminal 1 can be reduced.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the present embodiment, the information indicating that the closing operation is performed is included in the two-dimensional code. However, the information indicating that the closing operation is performed may not be included in the two-dimensional code. In this case, the settlement processing is performed based on the operation of the settlement key 172 in the POS terminal 1 in which the two-dimensional code is imaged.

Further, in the embodiment, the symbol information is input by imaging the barcode by the imaging unit 59 of the portable terminal 5. However, the symbol information indicated at a lower position of the barcode may be input by a key of the operation unit 57 of the portable terminal 5.

In the embodiment, the server 3 transmits application software to the portable terminal 5 and also collects sales information from the POS terminal 1. However, a server that transmits application software to the portable terminal 5 and a server that collects sales information from the POS terminal 1 may separately be provided.

Note that the program executed by the portable terminal 5 of the embodiment is stored as a file in an installable format or an executable format in a computer readable recording medium such as a CD-ROM, a flexible disk (FD), a CD-R, and a digital versatile disk (DVD) to be provided.

In addition, the program executed by the portable terminal 5 of the embodiment may be stored on a computer connected to a network such as the Internet, and may be provided by being downloaded via the network. Further, the program executed by the portable terminal 5 of the embodiment may be provided or distributed via a network such as the Internet.

In addition, the program executed by the portable terminal 5 of the embodiment may be provided by being incorporated in a ROM or the like in advance.

What is claimed is:

1. A portable point-of-sale apparatus, comprising:
a display;
an input device configured to capture symbol information affixed on a commodity; and
a processor configured to acquire commodity identification information for identifying the commodity based on the symbol information, perform sales registration processing for the commodity based on the acquired commodity identification information, and control the display to display a symbol image including the commodity identification information of the commodity in order for a settlement apparatus to read the symbol image.

2. The apparatus according to claim 1, further comprising:
a closing key,
wherein the symbol image includes information indicating that the closing key has been operated to indicate a closing operation, and
wherein the displayed symbol image includes information indicating that the closing operation is indicated.

3. The apparatus according to claim 1, wherein the processor is further configured to:
determine whether or not the settlement apparatus has completed settlement processing; and
transmit a non-settlement signal indicating that the settlement processing has not been completed upon determining that the settlement processing has not been completed.

4. The apparatus according to claim 3, wherein the processor is configured to control the display to display a message that the settlement processing has not been completed upon receiving the message from an external device.

5. The apparatus according to claim 4, wherein the commodity is registered at a store and the external device is located at an exit of the store.

6. The apparatus according to claim 3, wherein the processor is further configured to:
control the display to display a message indicating that the settlement has not been completed in response to the transmitted non-settlement signal.

7. The apparatus according to claim 1, wherein the processor is further configured to:
determine whether or not error information relating to weight check conducted by a settlement apparatus is received, and display error information for the transaction on the display unit if it is determined that the error information has been received.

8. A method of registering commodities for settlement, comprising:
capturing symbol information affixed on a commodity;
acquiring commodity identification information for identifying the commodity based on the symbol information performing sales registration processing for the commodity based on the acquired commodity identification information; and
displaying a symbol image including the commodity identification information of the commodity in order for a settlement apparatus to read the symbol image.

9. The method according to claim 8,
wherein the symbol image includes information indicating that a closing key has been operated to indicate a closing operation, and
wherein the displayed symbol image includes information indicating that the closing operation is indicated.

10. The method according to claim 8, further comprising:
determining whether or not the settlement apparatus has completed settlement processing; and
transmitting a non-settlement signal indicating that the settlement processing has not been completed upon determining that the settlement processing has not been completed.

11. The method according to claim 10, further comprising:
displaying a message that the settlement processing has not been completed upon receiving the message from an external device.

12. The method according to claim 11, wherein the commodity is registered at a store and the external device is located at an exit of the store.

13. The method according to claim 10, further comprising:
displaying a message indicating that the settlement has not been completed in response to the transmitted non-settlement signal.

14. The method according to claim 8, further comprising:
determining whether or not error information relating to weight check conducted by a settlement apparatus is received; and
displaying error information for the transaction on the display unit if it is determined that the error information has been received.

15. A non-transitory computer readable medium comprising instructions to be executed on a portable point-of-sale terminal, wherein the instructions when executed causes the portable point-of-sale terminal to carry out a method of registering commodities for settlement, said method comprising:
capturing symbol information affixed on a commodity;
acquiring commodity identification information for identifying the commodity based on the symbol information
performing sales registration processing for the commodity based on the acquired commodity identification information; and
displaying a symbol image including the commodity identification information of the commodity in order for a settlement apparatus to read the symbol image.

16. The non-transitory computer readable medium according to claim 15,
wherein the symbol image includes information indicating that a closing key has been operated to indicate a closing operation, and
wherein the displayed symbol image includes information indicating that the closing operation is indicated.

17. The non-transitory computer readable medium according to claim 15, wherein the method further comprises:
determining whether or not the settlement apparatus has completed settlement processing; and
transmitting a non-settlement signal indicating that the settlement processing has not been completed upon determining that the settlement processing has not been completed.

18. The non-transitory computer readable medium according to claim 17, wherein the method further comprises:
displaying a message that the settlement processing has not been completed upon receiving the message from an external device.

19. The non-transitory computer readable medium according to claim 17, wherein the method further comprises:
displaying a message indicating that the settlement has not been completed in response to the transmitted non-settlement signal.

20. The non-transitory computer readable medium according to claim 15, wherein the method further comprises:
determining whether or not error information relating to weight check conducted by a settlement apparatus is received; and
displaying error information for the transaction on the display unit if it is determined that the error information has been received.
